(19) United States
(12) Patent Application Publication
(10) Pub. No.: US 2003/0210150 A1
(43) Pub. Date: Nov. 13, 2003

(54) Drive awake

(76) Inventor: Robert Lorin Benedict, St. Petersburg, FL (US)

Correspondence Address: Robert L. Benedict, 6712 Cardinal Drive South, St. Petersburg, FL, 33707, US

(21) Appl. No.: 10/139,789

(22) Filed: May 7, 2002

(51) Int. Cl. G08B 23/00

(52) U.S. Cl. 340/575

(57) ABSTRACT

DRIVE AWAKE is a motor vehicle safety system that will create an alarm should the driver fail to adjust the steering wheel to the needs of the moving vehicle. This is possible by my recent discovery by observation of the almost continuous mini movements of the steering wheel by the driver of a moving vehicle. These regular movements or the absence of them can be electronically detected and trigger an alert alarm to the driver when needed.

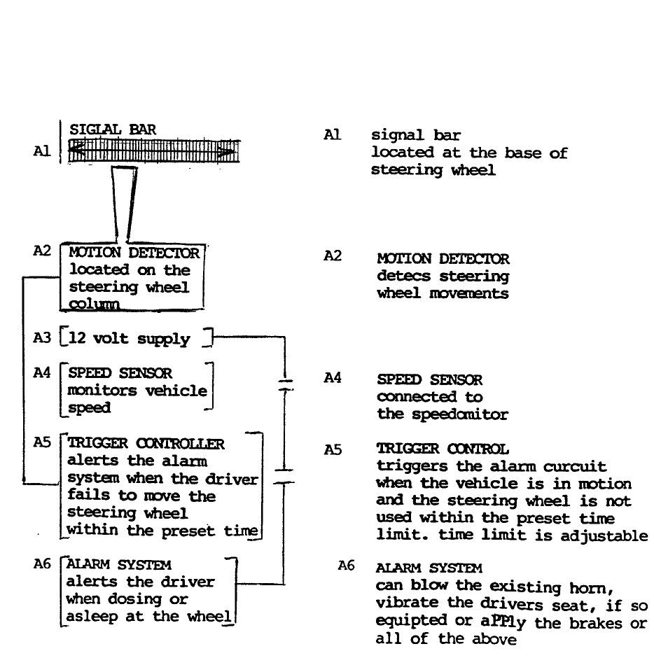

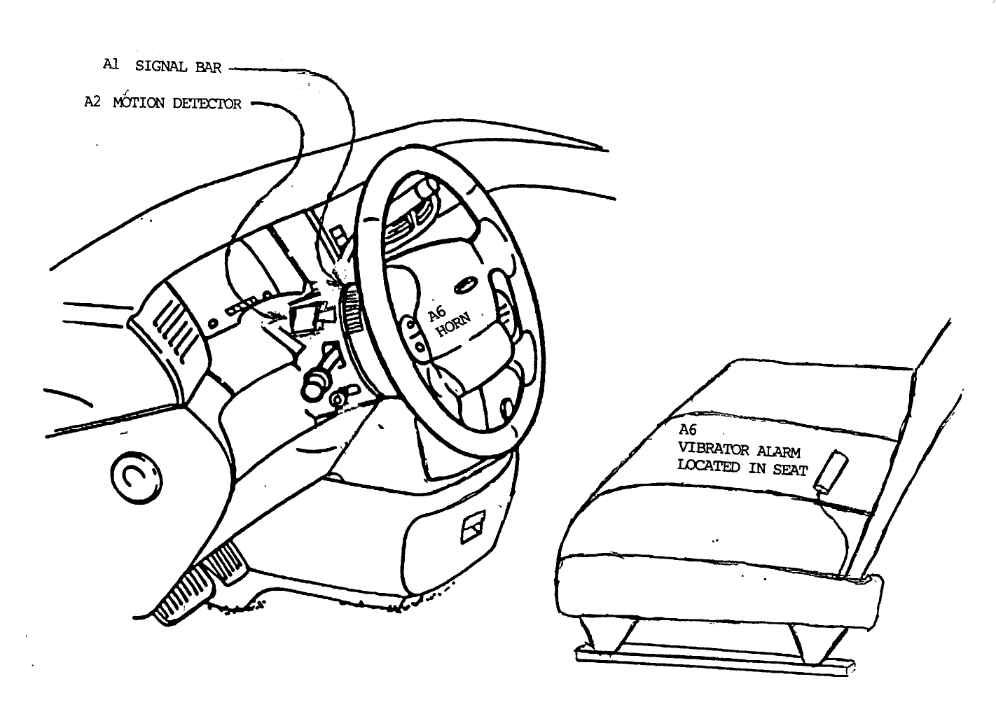

### SPECIFICATION

DRIVE AWAKE is a motor vehicle safety system that, when installed, will alert a driver in the event he or she has dosed off or is asleep at the steering wheel.

From my observation of many vehicle drivers, I have discovered that it is a common characteristic for every driver while driving a motor vehicle to regularly move the steering wheel ever so little either to the left or the right. This movement within every seven second or less time period is done regardless of the road conditions. When monitored, these ongoing mini movements can be used to determine whether a driver is awake or asleep at the wheel. A signal bar similar to a bar code may be attached to the base of the steering wheel and a corresponding motion detector may be located on the steering column adjacent to the signal bar. This will detect the back and forth motion of the steering wheel. This motion or the absence of it may be used to determine whether the driver is awake or asleep. However, when the signal ceases for seven seconds or more and the vehicle is in motion, an alarm is triggered to alert the driver. The alarm can consist of one or more alerting devices such as the existing horn, a vibrating seat cushion, apply the brakes or all the above.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

It is not uncommon to fall asleep at the wheel when you are tired and driving. This invention is intended to awaken a driver of a motor vehicle who has, while in motion, fallen asleep at the steering wheel.

I, Robert L. Benedict, have randomly observed twelve different vehicle drivers while driving. Each one regularly moves the steering wheel to the left or right every 7 seconds or less. These mini steering correction moves can sometimes be as little as a 0.25 inch when driving on a straight road or highway. The DRIVE AWAKE system will monitor these mini moves and alert the driver should he or she fall asleep.

### BRIEF SUMMARY OF THE INVENTION

This claimed invention is intended for the purpose of alerting a vehicle driver who has dosed or fallen asleep at the steering wheel.

### DESCRIPTION OF THE SEVERAL VIEWS OF THE DRAWING

Not Applicable

### DETAILED DESCRIPTION OF THE INVENTION

By continuously monitoring the mini movements of the steering wheel, this invention can determine whether the driver of the vehicle is awake. Should the driver stop moving the steering wheel for approximately 7 seconds (time may be adjusted to suit the individual driver or road conditions), the motion detector will detect absence of motion at the wheel and send a signal to a trigger device.

The trigger device, based on the existing speed of the vehicle, sends a signal to the alarm. The alarm sounds the existing horn or triggers other types of alerting devices within the vehicle. See Drawing A1, 2, 3, 4, 5 and 6.

I know of no other system/device or plan that uses this idea or concept. Should a patent be granted, my plan is to develop the electronic components as needed to install and use for my personal safety. I would sell the patent to a manufacturer who would manufacture and market it. I may manufacture it myself and market it through auto parts stores.

What I claim as my invention is:

1. From my observation of many vehicle drivers, I have discovered that it is a common characteristic for every driver while driving a motor vehicle to regularly move the steering wheel ever so little either to the left or the right within every seven second or less time period regardless of road conditions. By monitoring these motions and the absence of them, it can be determined whether the driver is awake or asleep at the wheel.
